(19) United States
(12) Patent Application Publication
(10) Pub. No.: US 2008/0299969 A1
(43) Pub. Date: Dec. 4, 2008

(54) METHOD AND SYSTEM FOR DEREGISTERING OUT-OF-COVERAGE RANGE DEVICES IN A WIRELESS LOCAL AREA NETWORK

(76) Inventor: Alexander Shatsky, Waterloo (CA)

Correspondence Address: McCarthy Tetrault LLP, Box 48, Suite #4700 Toronto Dominion Bank Tower, TORONTO, ON, M5K 1E6, CA

(21) Appl. No.: 11/755,012

(22) Filed: May 30, 2007

(51) Int. Cl. H04Q 7/20

(52) U.S. Cl. 455/435.1

(57) ABSTRACT

A method for deregistering wireless devices from a registration server for a wireless local area network, comprising: sending an initial registration request message from a wireless device to the registration server, the initial registration request message including an initial expiration interval; measuring radio signal strength at the wireless device; and, determining whether the radio signal strength has decreased to below a predetermined level and, if so, sending an updated registration request message from the wireless device to the registration server, the updated registration request message including an updated expiration interval less than the initial expiration interval thereby allowing timely deregistering of the wireless device by the registration server.

### FIELD OF THE APPLICATION

This application relates to the field of wireless communications between wireless and other devices, and more specifically, to a method and system for deregistering out-of-coverage range devices in a wireless local area network.

### BACKGROUND

Current wireless mobile communication devices include microprocessors, memory, soundcards, and run one or more software applications in addition to providing for voice communications. Examples of software applications used in these wireless devices include micro-browsers, address books, email clients, instant messaging (“IM”) clients, and wavetable instruments. Additionally, wireless devices have access to a plurality of services via the Internet. A wireless device may, for example, be used to browse web sites on the Internet, to transmit and receive graphics, and to execute streaming audio and/or video applications. Such wireless devices may operate on a cellular network, on a wireless local area network (“WLAN”), or on both of these types of networks.

With respect to WLANs, the term “Wi-Fi” (“Wireless Fidelity”) pertains to certain types of WLANs that use specifications in the Institute of Electrical and Electronics Engineers (“IEEE”) 802.11 family. Wi-Fi has gained acceptance in many businesses, office buildings, agencies, schools, and homes as an alternative to a wired local area network (“LAN”). The 802.11 family of specifications use the Ethernet protocol and Carrier Sense Multiple Access with Collision Avoidance (“CSMA/CA”) for path sharing. In addition, to improve security, entities running a WLAN often use security safeguards such as encryption or a virtual private network (“VPN”).

In a WLAN, an “access point” is a device that transmits and receives data (sometimes referred to as a transceiver). An access point connects users to other users within the network and also can serve as the point of interconnection between the WLAN and a wired LAN. Each access point can serve multiple users within a defined network area. As users move beyond the range of one access point (i.e., when they roam), they are automatically handed over to the next access point. A small WLAN may only require a single access point. The number of access points required increases as a function of the number of network users and the physical size of the network.

Now, the Session Initiation Protocol (“SIP”) is an Internet Engineering Task Force (“IETF”) standard protocol for initiating an interactive user session that involves multimedia elements such as voice, video, chat, gaming, and virtual reality. SIP is specified in IETF Request for Comments (“RFC”) 3261 “SIP: Session Initiation Protocol”, June 2002, which is incorporated herein by reference. Like the hypertext transfer protocol (“HTTP”) or the simple mail transfer protocol (“SMTP”), SIP works in the application layer of the Open Systems Interconnection (“OSI”) communications model. The application layer is the level responsible for ensuring that communication is possible. SIP may be used in a WLAN to establish multimedia sessions or Internet telephony calls, and modify, or terminate them. The protocol can also invite participants to unicast or multicast sessions that do not necessarily involve the initiator. Because SIP supports name mapping and redirection services, it makes it possible for users to initiate and receive communications and services from any location, and for networks to identify the users wherever they are.

In more detail, SIP is a client-server protocol which deals with requests from clients (e.g., wireless devices) and responses from servers (e.g., SIP servers). Participants are identified by SIP uniform resource locators (“URLs”). Requests can be sent through any transport protocol, such as the user datagram protocol (“UDP”), the stream control transmission protocol (“SCTP”), or the transmission control protocol (“TCP”). SIP determines the end system to be used for the session, the communication media and media parameters, and the called party's desire to engage in the communication. Once these are assured, SIP establishes call parameters at either end of the communication, and handles call transfer and termination.

Registration is a common operation in SIP. Registration is one way that a server can learn the current location of a wireless device. Upon initialization, and at periodic intervals, a user's SIP wireless device sends “REGISTER” request messages to a server in the user's domain that is operating as a SIP registrar. The REGISTER messages associate the user's SIP or SIPS (i.e., secure SIP) uniform resource identifier (“URI”) with the device into which the user is currently logged. The registrar writes this association, also called a binding, to a database, called the “location service”, where it can be used by a proxy server in the user's domain. The proxy server receives SIP requests and forwards them on behalf of the requester. Often, a registrar server for a domain is co-located with the proxy for that domain. In general, the distinction between types of SIP servers is logical, not physical. The location service is an abstract concept. It generally contains information that allows a proxy to input a URI and receive a set of zero or more URIs that tell the proxy where to send the request. Registrations are one way to create this information.

Thus, registration creates bindings in a location service for a particular domain that associates an “address-of-record” URI with one or more contact addresses. When a proxy for that domain receives a request whose request-URI matches the address-of-record, the proxy will forward the request to the contact addresses registered to that address-of-record. Registration thus entails sending a REGISTER request to a registrar which acts as the front end to the location service for a domain, reading and writing mappings based on the contents of REGISTER requests. This location service is then typically consulted by a proxy server that is responsible for routing requests for that domain.

REGISTER request messages add, remove, and query bindings. A REGISTER request can add a new binding between an address-of-record and one or more contact addresses. Registration on behalf of a particular address-of-record can be performed by a suitably authorized third party. A client can also remove previous bindings or query to determine which bindings are currently in place for an address-of-record.

According to SIP, the following header fields, except Contact, must be included in a REGISTER request. A Contact header field may be included: (1) “Request-URI”: The Request-URI names the domain of the location service for which the registration is meant (e.g., “sip:usercity.com”). The “userinfo” and “@” components of the SIP URI must not be present. (2) “To”: The To header field contains the address-of-record whose registration is to be created, queried, or modified. The To header field and the Request-URI field typically differ, as the former contains a user name. This address-of-record must be a SIP URI or SIPS URI. (3) “From”: The From header field contains the address-of-record of the person responsible for the registration. The value is the same as the To header field unless the request is a third party registration. (4) “Call-ID”: All registrations from a client should use the same Call-ID header field value for registrations sent to a particular registrar. If the same client were to use different Call-ID values, a registrar could not detect whether a delayed REGISTER request might have arrived out of order. (5) “CSeq”: The sequence number value guarantees proper ordering of REGISTER requests. (6) “Contact”: REGISTER requests may contain a Contact header field with zero or more values containing address bindings. The Contact header field may include an “expires” parameter. The “expires” parameter indicates how long a user would like the binding to be valid. The value is a number indicating seconds. If this parameter is not provided, the value of the “Expires” header field is used instead (see below).

Thus, with respect to setting the expiration interval of contact addresses in SIP, when a client sends a REGISTER request, it may suggest an expiration interval that indicates how long the client would like the registration to be valid. There are two ways in which a client can suggest an expiration interval for a binding: (1) Through an “Expires” header field; or, (2) Through an “expires” Contact header parameter. The latter allows expiration intervals to be suggested on a per-binding basis when more than one binding is given in a single REGISTER request, whereas the former suggests an expiration interval for all Contact header field values that do not contain the “expires” parameter. If neither mechanism for expressing a suggested expiration time is present in a REGISTER request, the client is indicating its desire for the server to choose.

For reference, the following is an example REGISTER request message sent from a user's wireless device to a registrar server including an Expires header field having a value of 3600 seconds for the expiration interval:

REGISTER sip:registrar.usercity.com SIP/2.0

Via: SIP/2.0/UDP user.usecity.com; branch=z9hG4bK776ads

To: User <sip:user@usercity.com>

From: User <sip:user@usercity.com>

Call-ID: 843817637684230@998sdasdh09

Contact: <sip:user@192.168.1.100>

CSeq: 1826 REGISTER

Expires: 3600

SIP deregistration procedures are not described in RFC 3261. However, the typical method used for deregistering a wireless device from a WLAN using SIP is to send a SIP REGISTER request message with the Expires header field value set to zero when the device is about to deregister from the SIP server. Once the device is deregistered, the SIP server will not route any further call requests to the device unless the device sends a new REGISTER request. This method provides for the following: (1) Reduced load on the network caused by non-relevant messages; (2) Reduced security vulnerability for users; and, (3) Immediate provision a called party's status to a calling party making the service more attractive to users.

A typical Expires header field value in a REGISTER request indicates an expiration interval of 3600 seconds. If the SIP server does not receive a “RE-REGISTER” message from the device after this interval of time, the registration will be considered expired and the device will be automatically marked as deregistered in the server. Alternatively, a server may delete the registration record from its tables. An expiration interval of 3600 seconds for the Expires header field allows for a reduction in unnecessary load on LAN networks, devices, and servers.

One problem with communications in Wi-Fi networks is that a SIP wireless device can get out of coverage range (e.g., beyond the range of an AP) before it sends the necessary deregistration message (i.e., a REGISTER request with the Expires header field value set to zero). This problem can defeat or reduce at least some of the advantages of registration described above.

A need therefore exists for an improved method and system for deregistering out-of-coverage range devices in a wireless local area network. Accordingly, a solution that addresses, at least in part, the above and other shortcomings is desired.

### BRIEF DESCRIPTION OF THE DRAWINGS

Features and advantages of the embodiments of the present application will become apparent from the following detailed description, taken in combination with the appended drawings, in which:

FIG. 1 is a block diagram illustrating a data processing system adapted for implementing an embodiment of the application;

FIG. 2 is a block diagram illustrating a wireless device and a wireless communications system adapted for implementing an embodiment of the application;

FIG. 3 is a block diagram illustrating a memory of the wireless device of FIG. 2;

FIG. 4 is a block diagram illustrating a wireless local area network (“WLAN”) coupled to a wired LAN in accordance with an embodiment of the application; and,

FIG. 5 is a flow chart illustrating operations of software modules within the memory of a wireless device for deregistering the wireless device from a registration server for a wireless local area network, in accordance with an embodiment of the application.

It will be noted that throughout the appended drawings, like features are identified by like reference numerals.

### DETAILED DESCRIPTION OF THE EMBODIMENTS

In the following description, details are set forth to provide an understanding of the application. In some instances, certain software, circuits, structures and techniques have not been described or shown in detail in order not to obscure the application. Embodiments of the present application may be implemented in any computer programming language provided that the operating system of the data processing system provides the facilities that may support the requirements of the application. Any limitations presented would be a result of a particular type of operating system or computer programming language and would not be a limitation of the present application.

According to one embodiment, there is provided a method for deregistering wireless devices from a registration server for a wireless local area network, comprising: sending an initial registration request message from a wireless device to the registration server, the initial registration request message including an initial expiration interval; measuring radio signal strength at the wireless device; and, determining whether the radio signal strength has decreased to below a predetermined level and, if so, sending an updated registration request message from the wireless device to the registration server, the updated registration request message including an updated expiration interval less than the initial expiration interval thereby allowing timely deregistering of the wireless device by the registration server.

The method may further include determining whether the radio signal strength has increased above the predetermined level and, if so, sending the initial registration request message including the initial expiration interval from the wireless device to the registration server thereby preventing untimely deregistering of the wireless device by the registration server. The initial and updated expiration intervals may be for indicating respective time periods after which the wireless device is to be deregistered from the registration server. The initial expiration interval may be a default expiration interval and the predetermined level may be a predetermined percentage of a relative maximum radio signal strength. The predetermined level may be a plurality of predetermined levels and the initial and updated expiration intervals may relate to one or more of the plurality of predetermined levels. The initial and updated registration request messages may be REGISTER request messages in accordance with the Session Initiation Protocol (“SIP”). Each of the initial and updated registration request messages may include an address for the wireless device, a call identification, and a call sequence number. The initial and updated expiration intervals may be Expires header field values in accordance with the Session Initiation Protocol (“SIP”). The registration server may be one or more of a registrar in accordance with the Session Initiation Protocol (“SIP”) and a proxy server. And, the wireless local area network may be a Wi-Fi network and the wireless device may be a Wi-Fi device.

In accordance with further aspects of the present application there are provided apparatus such as a data processing system and a wireless device, methods for adapting these, as well as articles of manufacture such as a computer readable medium having program instructions recorded therein for practicing the method of the application.

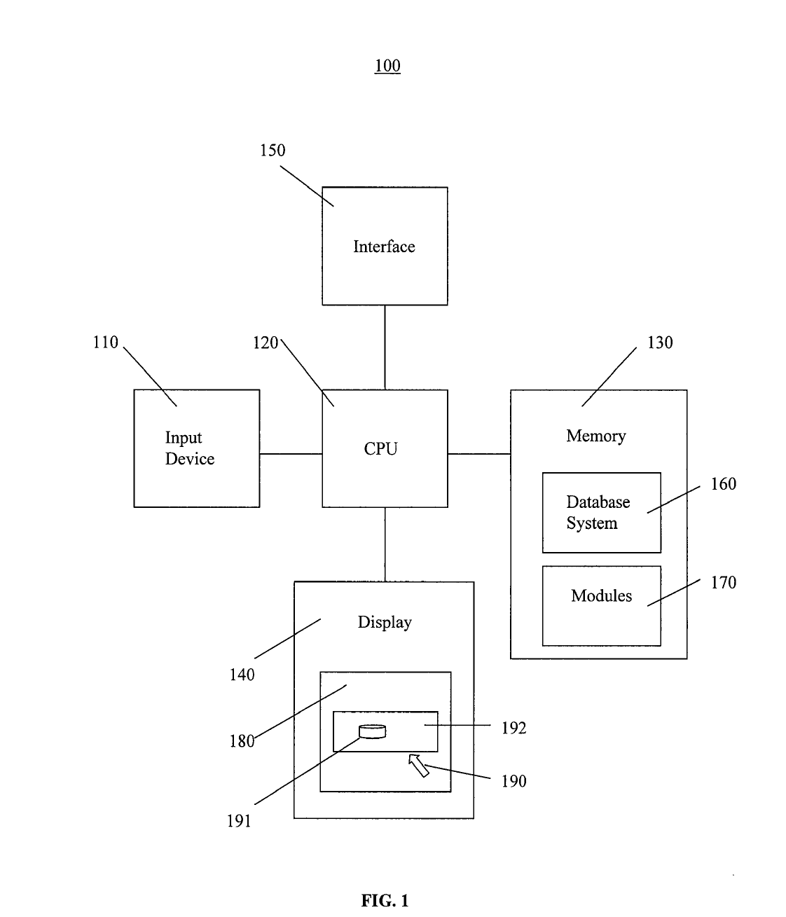

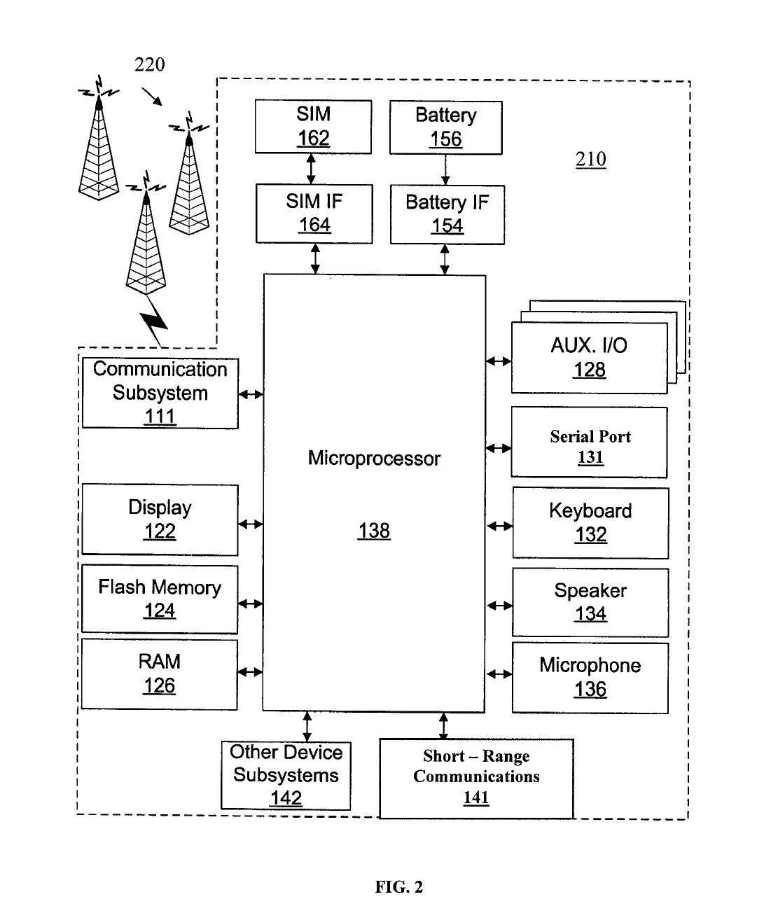

FIG. 1 is a block diagram illustrating a data processing system 100 adapted for implementing an embodiment of the application. The data processing system 100 includes an input device 110, a central processing unit or CPU 120, memory 130, a display 140, and an interface 150. The input device 110 may include a keyboard, mouse, trackball, remote control, or similar device. The CPU 120 may include dedicated coprocessors and memory devices. The memory 130 may include RAM, ROM, or disk devices. The display 140 may include a computer screen, terminal device, or a hardcopy producing output device such as a printer or plotter. And, the interface 150 may include a network connection including an Internet connection and a wireless network 220 connection (see FIG. 2). The data processing system 100 is adapted for communicating with wireless devices 210 over a wireless network 220.

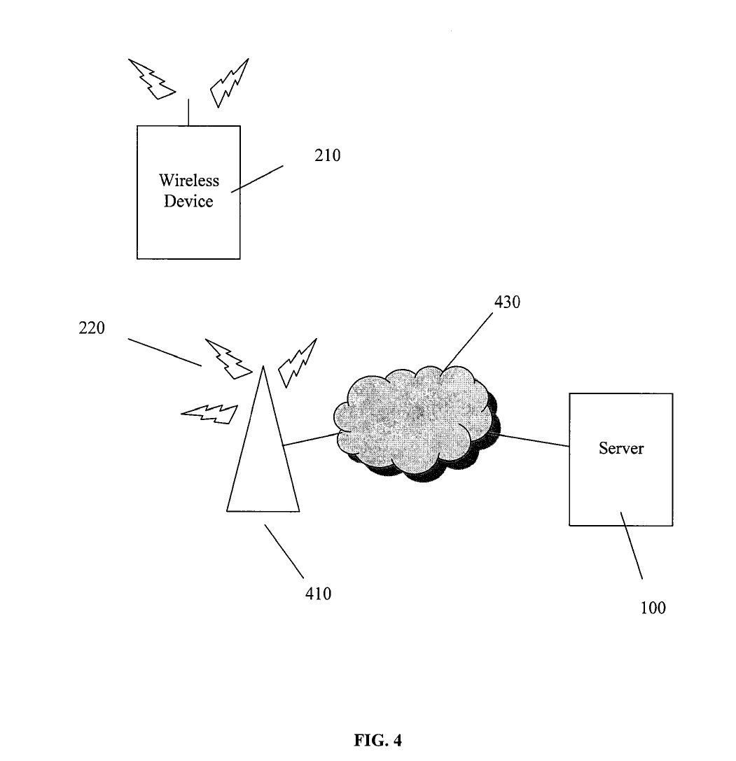

The data processing system 100 may be a server system or a personal computer (“PC”) system. The CPU 120 of the system 100 is operatively coupled to memory 130 which stores an operating system (not shown), such as IBM Corporation's OS/2™, UNIX, etc., for general management of the system 100. The interface 150 may be used for communicating to external data processing systems (e.g., access point 410 in FIG. 4) through a network (such as the Internet) or wireless network 220 (see FIG. 2).

The data processing system 100 may include a database system 160 for storing and accessing data and programming information. The database system 160 may include a database management system (“DBMS”) and a database and is stored in the memory 130 of the data processing system 100.

The data processing system 100 includes computer executable programmed instructions for directing the system 100 to implement the embodiments of the present application. The programmed instructions may be embodied in one or more hardware or software modules 170 which may be resident in the memory 130 of the data processing system 100. Alternatively, the programmed instructions may be embodied on a computer readable medium (such as a CD disk or floppy disk) which may be used for transporting the programmed instructions to the memory 130 of the data processing system 100. Alternatively, the programmed instructions may be embedded in a computer-readable signal or signal-bearing medium that may be uploaded to a network by a vendor or supplier of the programmed instructions, and this signal or signal-bearing medium may be downloaded through the interface 150 to the data processing system 100 from the network by end users or potential buyers.

The CPU 120 of the system 100 is typically coupled to one or more devices 110 for receiving user commands or queries and for displaying the results of these commands or queries to the user on a display 140. As mentioned, the memory 130 may include a variety of storage devices including internal memory and external mass storage typically arranged in a hierarchy of storage as understood to those skilled in the art.

A user may interact with the data processing system 100 and its software modules 170 using a graphical user interface (“GUI”) 180. The GUI 180 may be used for monitoring, managing, and accessing the data processing system 100. GUIs are supported by common operating systems and provide a display format which enables a user to choose commands, execute application programs, manage computer files, and perform other functions by selecting pictorial representations known as icons, or items from a menu through use of an input or pointing device such as a mouse 110. In general, a GUI is used to convey information to and receive commands from users and generally includes a variety of GUI objects or controls, including icons, toolbars, drop-down menus, text, dialog boxes, buttons, and the like. A user typically interacts with a GUI 180 presented on a display 140 by using an input or pointing device (e.g., a mouse) 110 to position a pointer or cursor 190 over an object 191 and by “clicking” on the object 191.

Typically, a GUI based system presents application, system status, and other information to the user in “windows” appearing on the display 140. A window 192 is a more or less rectangular area within the display 140 in which a user may view an application or a document. Such a window 192 may be open, closed, displayed full screen, reduced to an icon, increased or reduced in size, or moved to different areas of the display 140. Multiple windows may be displayed simultaneously, such as: windows included within other windows, windows overlapping other windows, or windows tiled within the display area.

FIG. 2 is a block diagram illustrating a wireless device 210 and a wireless network 220 adapted for implementing an embodiment of the application. The wireless network 220 may include antenna, base stations, access points, transceivers, supporting radio equipment, etc., known to those of ordinary skill in the art, for supporting wireless communications between the wireless device 210 and the data processing system 100. The wireless network 220 may be coupled to a wireless network gateway (not shown) and to a local area network (e.g., wired LAN 430 in FIG. 4) to which the data processing system 100 may be coupled through its interface 150.

The wireless device 210 may be a two-way communication device having at least voice and advanced data communication capabilities, including the capability to communicate with other computer systems 100. Depending on the functionality provided by the device 210, it may be referred to as a data messaging device, a two-way pager, a cellular telephone with data messaging capabilities, a wireless Internet appliance, a data communication device (with or without telephony capabilities), a Wi-Fi device, a WLAN device, or a dual-mode (i.e., Wi-Fi and cellular) device. The device 210 may communicate with any one of a plurality of fixed transceiver stations (e.g., 410 in FIG. 4) within its geographic coverage area.

The wireless device 210 will normally incorporate a communication subsystem 111, which includes a RF receiver, a RF transmitter, and associated components, such as one or more (preferably embedded or internal) antenna elements, local oscillators (“LOs”), and a processing module such as a digital signal processor (“DSP”) (all not shown). As will be apparent to those skilled in the field of communications, the particular design of the communication subsystem 111 depends on the communication network 220 in which the device 210 is intended to operate.

Cellular network access may be associated with a subscriber or user of the device 210 and therefore the device 210 may have a Subscriber Identity Module (or “SIM” card) 162 for inserting into a SIM interface (“IF”) 164 in order to operate on the network (e.g., a global system for mobile communication (“GSM”) network).

The device 210 may be a battery-powered device so it may also include a battery IF 154 for receiving one or more rechargeable batteries 156. Such a battery 156 provides electrical power to most if not all electrical circuitry in the device 210, and the battery IF 154 provides for a mechanical and electrical connection for it. The battery IF 154 is coupled to a regulator (not shown) which provides power to the circuitry of the device 210.

The wireless device 210 includes a microprocessor 138 which controls overall operation of the device 210. Communication functions, including at least data and voice communications, are performed through the communication subsystem 111. The microprocessor 138 also interacts with additional device subsystems such as a display 122, a flash memory 124 or other persistent store, a random access memory (“RAM”) 126, auxiliary input/output (“I/O”) subsystems 128, a serial port (e.g., a universal serial bus (“USB”) port) 131, a keyboard 132, a clickable thumbwheel (not shown), a speaker 134, a microphone 136, a short-range communications subsystem 141, and any other device subsystems generally designated at 142. Some of the subsystems shown in FIG. 2 perform communication-related functions, whereas other subsystems may provide “resident” or on-device functions. Notably, some subsystems, such as the keyboard 132, display 122, and clickable thumbwheel, for example, may be used for both communication-related functions, such as entering a text message for transmission over a communication network, and device-resident functions such as a calculator or task list. Operating system software used by the microprocessor 138 is preferably stored in a persistent store such as the flash memory 124, which may alternatively be a read-only memory (“ROM”) or similar storage element (not shown). Those skilled in the art will appreciate that the operating system, specific device applications, or parts thereof, may be temporarily loaded into a volatile store such as RAM 126.

The microprocessor 138, in addition to its operating system functions, preferably enables execution of software applications on the device 210. A predetermined set of applications which control basic device operations, including at least data and voice communication applications, will normally be installed on the device 210 during its manufacture. A preferred application that may be loaded onto the device 210 may be a personal information manager (“PIM”) application having the ability to organize and manage data items relating to the user such as, but not limited to, instant messaging (“IM”), email, calendar events, voice mails, appointments, and task items. Naturally, one or more memory stores are available on the device 210 and SIM 162 to facilitate storage of PIM data items and other information.

The PIM application preferably has the ability to send and receive data items via the wireless network 220. In a preferred embodiment, PIM data items are seamlessly integrated, synchronized, and updated via the wireless network, with the wireless device user's corresponding data items stored and/or associated with a host computer system such as the data processing system 100 thereby creating a mirrored host computer on the device 210 with respect to such items. This is especially advantageous where the host computer system is the wireless device user's office computer system. Additional applications may also be loaded onto the device 210 through the network 220, the auxiliary I/O subsystem 128, the serial port 131, the short-range communications subsystem 141, or any other suitable subsystem 142, and installed by a user in RAM 126 or preferably in a non-volatile store (not shown) for execution by the microprocessor 138. Such flexibility in application installation increases the functionality of the device 210 and may provide enhanced on-device functions, communication-related functions, or both. For example, secure communication applications may enable electronic commerce functions and other such financial transactions to be performed using the wireless device 210.

In a data communication mode, a received signal such as a text message, an email message, or web page download will be processed by the communication subsystem 111 and input to the microprocessor 138. The microprocessor 138 will preferably further process the signal for output to the display 122 and/or to the auxiliary I/O device 128. A user of the wireless device 210 may also compose data items, such as email messages, for example, using the keyboard 132 in conjunction with the display 122, the clickable thumbwheel, and possibly the auxiliary I/O device 128. The keyboard 132 is preferably a complete alphanumeric keyboard and/or a telephone-type keypad. These composed items may be transmitted over a communication network 220 through the communication subsystem 111 or the short range communication subsystem 141.

For voice communications, the overall operation of the wireless device 210 is substantially similar, except that the received signals would be output to the speaker 134 and signals for transmission would be generated by the microphone 136. Alternative voice or audio I/O subsystems, such as a voice message recording subsystem, may also be implemented on the device 210. Although voice or audio signal output is preferably accomplished primarily through the speaker 134, the display 122 may also be used to provide, for example, an indication of the identity of a calling party, duration of a voice call, or other voice call related information.

The serial port 131 shown in FIG. 2 is normally implemented in a personal digital assistant (“PDA”)-type communication device for which synchronization with a user's desktop computer is a desirable, albeit optional, component. The serial port 131 enables a user to set preferences through an external device or software application and extends the capabilities of the device 210 by providing for information or software downloads to the device 210 other than through a wireless communication network 220. The alternate download path may, for example, be used to load an encryption key onto the device 210 through a direct and thus reliable and trusted connection to thereby provide secure device communication.

The short-range communications subsystem 141 shown in FIG. 2 is an additional optional component which provides for communication between the device 210 and different systems or devices, which need not necessarily be similar devices. For example, the subsystem 141 may include an infrared device and associated circuits and components, or a Bluetooth™ communication module to provide for communication with similarly-enabled systems and devices. (Bluetooth™ is a registered trademark of Bluetooth SIG, Inc.)

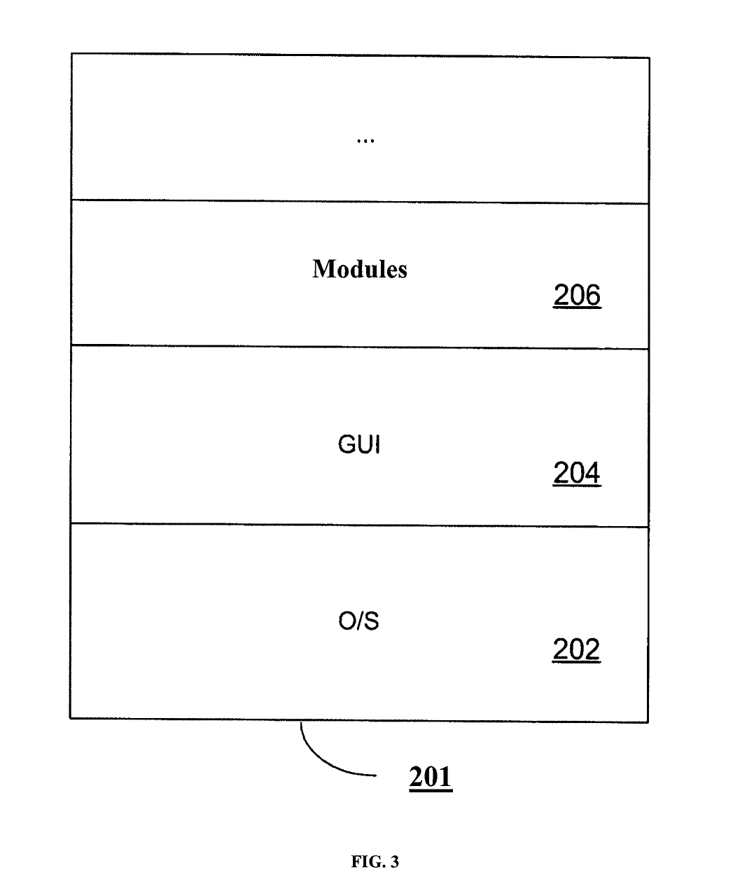

FIG. 3 is a block diagram illustrating a memory 201 of the wireless device 210 of FIG. 2. The memory 201 has various software components for controlling the device 210 and may include flash memory 124, RAM 126, or ROM (not shown), for example. In accordance with an embodiment of the invention, the wireless device 210 is intended to be a multi-tasking wireless communications device configured for sending and receiving data items and for making and receiving voice calls. To provide a user-friendly environment to control the operation of the device 210, an operating system (“O/S”) 202 resident on the device 210 provides a basic set of operations for supporting various applications typically operable through a graphical user interface (“GUI”) 204. For example, the O/S 202 provides basic input/output system features to obtain input from the auxiliary I/O 128, the keyboard 132, the clickable thumbwheel, and the like, and for facilitating output to the user. Though not shown, one or more applications for managing communications or for providing personal digital assistant like functions may also be included. In accordance with an embodiment of the application, there are provided software modules 206 for facilitating the method of the application as will be described below.

Thus, the wireless device 210 includes computer executable programmed instructions for directing the device 210 to implement the embodiments of the present application. The programmed instructions may be embodied in one or more hardware or software modules 206 which may be resident in the memory 201 of the wireless device 210. Alternatively, the programmed instructions may be embodied on a computer readable medium (such as a CD disk or floppy disk) which may be used for transporting the programmed instructions to the memory of the wireless device 210. Alternatively, the programmed instructions may be embedded in a computer-readable signal or signal-bearing medium that may be uploaded to a network by a vendor or supplier of the programmed instructions, and this signal or signal-bearing medium may be downloaded through an interface 111, 131, 141 to the wireless device 210 from the network by end users or potential buyers.

FIG. 4 is a block diagram illustrating a wireless local area network (“WLAN”) 220 coupled to a wired LAN 430 in accordance with an embodiment of the application. One or more wireless devices 210, each adapted for WLAN operation, communicate over the wireless network 220 to one or more WLAN access points 410. The access point 410 is typically an IEEE 802.11 (i.e., Wi-Fi) radio receiver/transmitter (or transceiver) and functions as a bridge between the WLAN 220 and the wired LAN 430. For security, each access point 410 may be communicatively coupled to the wired LAN 430 through a firewall and/or VPN (not shown).

On the wired LAN side of the firewall/VPN is at least one data processing system 100 configured to operate as a SIP server, SIP proxy server, and/or SIP registration server (or registrar). The SIP server 100 is a call server that negotiates a call setup on the user's behalf. For example, the server 100 provides information to indicate whether a party participating in the call is absent, busy, forwarded, or not taking calls. The SIP server 100 may be coupled to a private branch exchange (“PBX”) (not shown) to which may be coupled one or more telephone handsets (not shown) and an interface to the public switched telephone network (“PSTN”) (not shown). A PBX is a telephone system within an enterprise that switches calls between enterprise users on local lines while allowing all users to share a certain number of external phone lines coupled to the PSTN. Typically, the SIP server 100 is located at the enterprise customer premises, much the same as the PBX is located on site.

In general, the SIP server 100 is not tied into the cellular network directly. However, to provide cellular telephone services such as email service, etc., the wireless devices 210 may have access to email enterprise server (not shown) located on the wired LAN 430. The email enterprise server may have a hardware configuration similar to that of the SIP server 100. Accordingly, the wireless device 210 may be a simple Wi-Fi device or it may be a more sophisticated dual-mode device including both Wi-Fi and cellular functionality.

According to one embodiment, the wireless devices 210 may be dual-mode devices having both Wi-Fi and cellular functionality. In this embodiment, the wireless devices 210 are also able to communicate over a cellular network (not shown), such as a GSM network, linked to the wired LAN 430.

Thus, a user of a wireless device 210 may engage in an email exchange or a telephone voice call with other wireless device users or with the user of a wired telephone handset or with a user on the PSTN, all through the WLAN 220 coupled through the access point 410 to the SIP server 100 on the wired LAN 430.

As mentioned above, the SIP server 100 is a call server that negotiates a call setup on the user's behalf. The SIP server 100 uses SIP for the signalling used to setup a voice call. Much like an operator-assisted call, SIP provides for the messages each end exchanges to determine what device 210 is called, whether that device 210 is available, etc.

Also as mentioned above, SIP is a client-server protocol, dealing with requests from clients 210 and responses from servers 100. Participants are identified by SIP uniform resource locators (“URLs”). Requests can be sent through any transport protocol, such as the user datagram protocol (“UDP”), the stream control transmission protocol (“SCTP”), or the transmission control protocol (“TCP”). SIP determines the end system to be used for the session, the communication media and media parameters, and the called party's desire to engage in the communication. Once these are assured, SIP establishes call parameters at either end of the communication, and handles call transfer and termination.

Also as mentioned above, SIP deregistration procedures are not described in RFC 3261. However, the typical method used for deregistering a wireless device 210 from a WLAN 220 using SIP is to send a SIP “REGISTER” request message with the “Expires” header set to zero when the device 210 is about to deregister from the SIP server 100. Once the device 210 is deregistered, the SIP server 100 will not route any further call requests to the device 210 unless the device 210 sends a new REGISTER request.

Also as mentioned above, a typical Expires header field value in a REGISTER request indicates an expiration interval of 3600 seconds. If the SIP server 100 does not receive a “RE-REGISTER” message from the device 210 after this interval of time, the registration will be considered expired and the device 210 will be automatically marked as deregistered in the server 100. An expiration interval of 3600 seconds for the Expires header field allows for a reduction in unnecessary load on WLANs 220, LANs 430, devices 210, and servers 100.

Also as mentioned above, one problem with communications in Wi-Fi networks 220 is that a SIP wireless device 210 can get out of coverage range (e.g., beyond the range of an AP 410) before it sends the necessary deregistration message (i.e., a REGISTER request with the Expires header field value set to zero). This problem can defeat or reduce at least some of the advantages of registration described above.

The present application provides a system and method for deregistering out-of-coverage range devices (e.g., 210) in a wireless local area network (e.g., 220). According to one embodiment, the SIP Wi-Fi device 210 has means for monitoring (e.g., measuring continuously) radio signal strength. Once the signal strength decreases to a predetermined threshold or level (e.g., signal strength is 10-15% of a relative maximum signal strength), the device 210 composes and sends a “RE-REGISTER” request with a very short expiration interval (e.g., the value of the Expires header field may be set to 30-120 seconds). Note that a RE-REGISTER request is the same as a REGISTER request in SIP. If the device 210 is in the process of completely loosing connection to the network 220, the server 100 will deregister the device 210 after the above mentioned shortened (i.e., 30-120 seconds) expiration interval in the RE-REGISTER request. Otherwise, if the device 210 is still in range, the device 210 will send a new RE-REGISTER request having an Expires header field value adjusted in accordance with the measured radio signal strength. In particular, if radio signal strength as measured by the device 210 is decreasing, the value of the Expires header field will be decreased. In contrast, if radio signal strength as measured by the device 210 is increasing, the value of the Expires header field will be increased.

Radio signal strength may be affected by one or more of the following: the distance between the wireless device 210 and the access point 410; the presence of obstacles to Wi-Fi signals such as walls, buildings, etc.; weather conditions such as rain, wind, etc.; and, electromagnetic storms and related phenomena.

According to one embodiment, a plurality of predetermined radio signal strength thresholds or levels may be provided. For example, predetermined thresholds corresponding to the following relative signal strengths may be provided: excellent, very good, good, poor (or weak), and very poor (or very weak). Consider the following example. First, the signal strength is determined to be above the “excellent” threshold. As such, an initial REGISTER request with an expiration interval of 3600 seconds (for example) is sent. The 3600 second expiration interval may be considered as a “default” expiration interval. Second, the signal strength is determined to have decreased to below the “poor” threshold. As such, a RE-REGISTER request with an expiration interval of 120 seconds (for example) is sent. Third, the signal strength is determined to have decreased further to below the “very poor” threshold. As such, a RE-REGISTER request with an expiration interval of 30 seconds (for example) is sent. Fourth, the signal strength is determined to have increased to above the “very poor” threshold but below the “poor threshold”. As such, a RE-REGISTER request with an expiration interval of 120 seconds is sent. Fifth, the signal strength is determined to have increased further to above the “excellent” threshold. As such, a RE-REGISTER request with an expiration interval of 3600 seconds is sent. Sixth, the signal strength is determined to have decreased again to below the “very poor” threshold. As such, a RE-REGISTER request with an expiration interval of 30 seconds is sent. In the preceding example, the expiration intervals of 30 and 120 seconds could be 300 and 600 seconds, respectively (for example), or any other predetermined expiration intervals below the default expiration interval of 3600 seconds.

According to one embodiment, the method of the present application may be used for SIP “SUBSCRIBE” requests that include an Expires header field. A SUBSCRIBE request is used to request current state and state updates from a remote node and is described in IETF RFC 3265 “Session Initiation Protocol (SIP)—Specific Event Notification”, June 2002, which is incorporated herein by reference.

According to another embodiment, the method of the present application may be used for SIP “RE-INVITE” requests that include a “Session-Expires” header field. A RE-INVITE request allows for a periodic refresh of SIP sessions allowing clients and servers to determine whether the SIP session is still active. The RE-INVITE request is described in IETF RFC 4028 “Session Timers in the Session Initiation Protocol (SIP)”, April 2005, which is incorporated herein by reference.

The application provides several advantages. For example, the method of the present application allows wireless devices to be deregistered from SIP registration servers (i.e., SIP registrars) more efficiently.

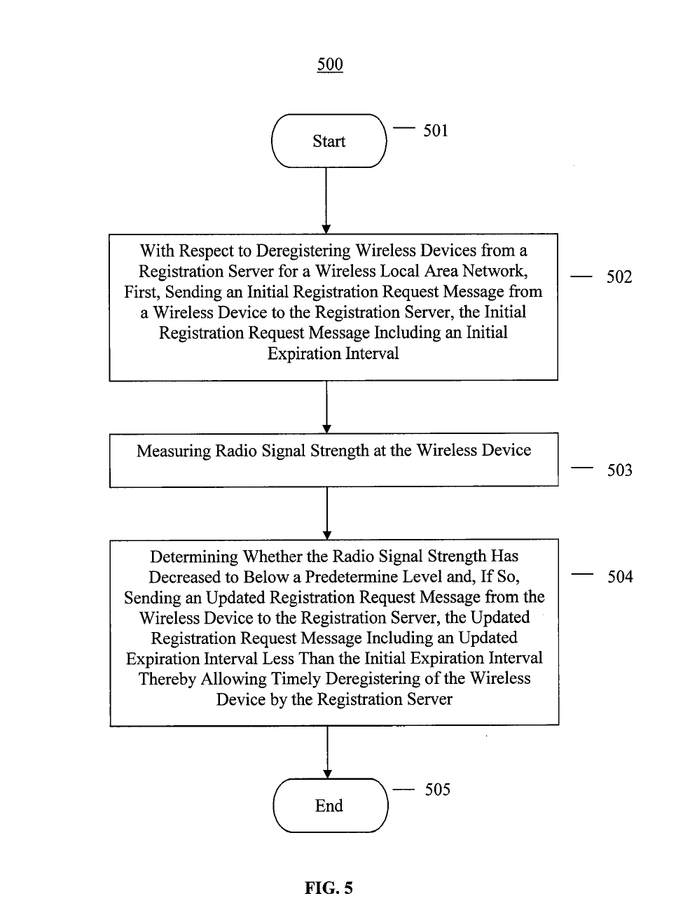

Aspects of the above described method may be summarized with the aid of a flowchart. FIG. 5 is a flow chart illustrating operations 500 of software modules 206 within the memory 201 of a wireless device 210 for deregistering the wireless device 210 from a registration server 100 for a wireless local area network 220, in accordance with an embodiment of the application.

At step 501, the operations 500 start.

At step 502, an initial registration request message is sent from the wireless device 210 to the registration server 100, the initial registration request message including an initial expiration interval (e.g., 3600 seconds).

At step 503, radio signal strength is measured at the wireless device 210.

At step 504, a determination is made as to whether the radio signal strength has decreased to below a predetermined level (e.g., “poor”, 10-15% of maximum, etc.) and, if so, an updated registration request message is sent from the wireless device 210 to the registration server 100, the updated registration request message including an updated expiration interval (e.g., 120 seconds) less than the initial expiration interval thereby allowing timely deregistering of the wireless device 210 by the registration server 100.

At step 505, the operations 500 end.

The method may further include determining whether the radio signal strength has increased above the predetermined level and, if so, sending the initial registration request message including the initial expiration interval from the wireless device 210 to the registration server 100 thereby preventing untimely deregistering of the wireless device 210 by the registration server 100. The initial and updated expiration intervals may be for indicating respective time periods after which the wireless device 210 is to be deregistered from the registration server 100. The initial expiration interval may be a default expiration interval and the predetermined level may be a predetermined percentage of a relative maximum radio signal strength. The predetermined level may be a plurality of predetermined levels (e.g., excellent, very good, good, poor, very poor) and the initial and updated expiration intervals may relate to one or more of the plurality of predetermined levels. The initial and updated registration request messages may be REGISTER request messages in accordance with the Session Initiation Protocol (“SIP”). Each of the initial and updated registration request messages may include an address for the wireless device 210, a call identification, and a call sequence number. The initial and updated expiration intervals may be Expires header field values in accordance with the Session Initiation Protocol (“SIP”). The registration server 100 may be one or more of a registrar in accordance with the Session Initiation Protocol (“SIP”) and a proxy server. And, the wireless local area network 220 may be a Wi-Fi network and the wireless device 210 may be a Wi-Fi device.

The above described method is generally performed by the wireless device 210. However, according to an alternate embodiment, the method can be performed by, or in combination with, the data processing system 100.

While embodiments of this application are primarily discussed as a method, a person of ordinary skill in the art will understand that the apparatus discussed above with reference to a wireless device 210 and a data processing system 100, may be programmed to enable the practice of the method of these embodiments. Moreover, an article of manufacture for use with a wireless device 210 or data processing system 100, such as a pre-recorded storage device or other similar computer readable medium including program instructions recorded thereon, may direct the wireless device 210 or data processing system 100 to facilitate the practice of the method of these embodiments. It is understood that such apparatus and articles of manufacture also come within the scope of the application.

The embodiments of the application described above are intended to be exemplary only. Those skilled in this art will understand that various modifications of detail may be made to these embodiments, all of which come within the scope of the application.

What is claimed is:

1. A method for deregistering wireless devices from a registration server for a wireless local area network, comprising:
sending an initial registration request message from a wireless device to the registration server, the initial registration request message including an initial expiration interval;
measuring radio signal strength at the wireless device; and,
determining whether the radio signal strength has decreased to below a predetermined level and, if so, sending an updated registration request message from the wireless device to the registration server, the updated registration request message including an updated expiration interval less than the initial expiration interval thereby allowing timely deregistering of the wireless device by the registration server.

2. The method of claim 1 and further comprising determining whether the radio signal strength has increased above the predetermined level and, if so, sending the initial registration request message including the initial expiration interval from the wireless device to the registration server thereby preventing untimely deregistering of the wireless device by the registration server.

3. The method of claim 2 wherein the initial and updated expiration intervals are for indicating respective time periods after which the wireless device is to be deregistered from the registration server.

4. The method of claim 3 wherein the initial expiration interval is a default expiration interval and wherein the predetermined level is a predetermined percentage of a relative maximum radio signal strength.

5. The method of claim 3 wherein the predetermined level is a plurality of predetermined levels and wherein the initial and updated expiration intervals relate to one or more of the plurality of predetermined levels.

6. The method of claim 3 wherein the initial and updated registration request messages are REGISTER request messages in accordance with the Session Initiation Protocol (“SIP”).

7. The method of claim 6 wherein each of the initial and updated registration request messages includes an address for the wireless device, a call identification, and a call sequence number.

8. The method of claim 6 wherein the initial and updated expiration intervals are Expires header field values in accordance with the Session Initiation Protocol (“SIP”).

9. The method of claim 8 wherein the registration server is one or more of a registrar in accordance with the Session Initiation Protocol (“SIP”) and a proxy server.

10. The method of claim 9 wherein the wireless local area network is a Wi-Fi network and the wireless device is a Wi-Fi device.

11. A system within a wireless device for deregistering the wireless device from a registration server for a wireless local area network, the system comprising:
a processor coupled to memory and to an interface to the wireless local area network; and,
modules within the memory and executed by the processor, the modules including:
a module for sending an initial registration request message from the wireless device to the registration server, the initial registration request message including an initial expiration interval;
a module for measuring radio signal strength at the wireless device; and,
a module for determining whether the radio signal strength has decreased to below a predetermined level and, if so, sending an updated registration request message from the wireless device to the registration server, the updated registration request message including an updated expiration interval less than the initial expiration interval thereby allowing timely deregistering of the wireless device by the registration server.

12. The system of claim 11 and further comprising a module for determining whether the radio signal strength has increased above the predetermined level and, if so, sending the initial registration request message including the initial expiration interval from the wireless device to the registration server thereby preventing untimely deregistering of the wireless device by the registration server.

13. The system of claim 12 wherein the initial and updated expiration intervals are for indicating respective time periods after which the wireless device is to be deregistered from the registration server.

14. The system of claim 13 wherein the initial expiration interval is a default expiration interval and wherein the predetermined level is a predetermined percentage of a relative maximum radio signal strength.

15. The system of claim 13 wherein the predetermined level is a plurality of predetermined levels and wherein the initial and updated expiration intervals relate to one or more of the plurality of predetermined levels.

16. The system of claim 13 wherein the initial and updated registration request messages are REGISTER request messages in accordance with the Session Initiation Protocol (“SIP”).

17. The system of claim 16 wherein each of the initial and updated registration request messages includes an address for the wireless device, a call identification, and a call sequence number.

18. The system of claim 16 wherein the initial and updated expiration intervals are Expires header field values in accordance with the Session Initiation Protocol (“SIP”).

19. The system of claim 18 wherein the registration server is one or more of a registrar in accordance with the Session Initiation Protocol (“SIP”) and a proxy server.

20. The system of claim 19 wherein the wireless local area network is a Wi-Fi network and the wireless device is a Wi-Fi device.
